(19) United States
(12) Patent Application Publication
(10) Pub. No.: US 2008/0050261 A1
(43) Pub. Date: Feb. 28, 2008

(54) CONTACTING BEARING PROTECTOR

(76) Inventor: Alan James Roddis, Sheffield (GB)

Correspondence Address: EDWIN D. SCHINDLER, FIVE HIRSCH AVENUE, P.O. BOX 966, CORAM, NY, 11727-0966, US

(21) Appl. No.: 11/843,164

(22) Filed: Aug. 22, 2007

(30) Foreign Application Priority Data
Aug. 22, 2006 (GB) 0616639.1

(51) Int. Cl. F03C 4/00

(52) U.S. Cl. 418/104

(57) ABSTRACT

A contacting seal device provides a seal between equipment housing and an equipment shaft. The contacting seal device includes a stator that can be sealed to the equipment housing by a first torroidal sealing member, a first rotor that can be sealed to the equipment shaft by a second torroidal sealing member and a second rotor mounted for longitudinal movement relative to the first rotor and sealed to the first rotor by a third torroidal sealing member. The stator and the second rotor each have contact faces and one or more biasing devices urge the contact face of the second rotor into engagement with the contract face of the stator.

### BACKGROUND OF THE INVENTION

1. Technical Field of the Invention

This invention relates to contacting seals and their use in rotating equipment, especially devices which prevent the ingress or egress of a fluid or solid to a cavity within the equipment, which results in deterioration of equipment life. Such devices are often referred to as bearing protectors, bearing seals or bearing isolators. However, the use of such rotary seals extends well beyond the protection of a bearing in rotating equipment. Accordingly, while reference will be made below to bearing protectors, it should be understood that this term is used, as far as the invention is concerned, in connection with such wider uses.

2. Description of the Prior Art

The purpose of a bearing protector is to prevent the ingress of fluid, solids and/or debris from entering a bearing chamber. Equally, bearing protectors are employed to prevent the egress of fluid or solids from a bearing chamber. Essentially, their purpose is to prevent the premature failure of the bearing.

Bearing protectors generally fall into two categories: repeller or labyrinth bearing protectors; and mechanical seal bearing protectors. Reference is made to our co-pending labyrinth seal bearing protection United Kingdom patent application, No. GB 0415548.7, which defines a substantially non-contacting bearing protector with static shut off device.

In a labyrinth seal, the rotating component typically has a complex outer profile which is located adjacent and in close radial and axial proximity to a complex inner profile of the stationary component. Together these complex profiles, in theory, provide a tortuous path preventing the passage of the unwanted materials or fluids.

Given the fact that conventional labyrinth technology provides a non-contacting interface between the rotor and stator, its use in certain applications, such as flooded or pressurised environments, is limited.

Contacting bearing seals are thus designed to overcome the inherent drawbacks of non-contacting designs and reference is made to our United Kingdom patent application, No. GB 0215750.1.

Often, contacting bearing seals incorporate one or more magnets to attract together two, substantially sliding components, one rotor and one stator, and thus create a sealing interface. Such designs have limited effectiveness in rotating equipment, in which longitudinal shaft movement takes place.

Dawson, U.S. Pat. No. 5,730,447, teaches a floating inner annulus on the stator, which helps to keep the contact faces in contact. However, its effectiveness in the field is limited: hence the further teaching of Dawson, U.S. Pat. No. 6,805,358.

U.S. Pat. No. 6,805,358 teaches an annular surface which acts to limit the axial separation of one contact face with respect to the other, under longitudinal shaft movement.

Unfortunately, in practice, the physical separation of the two sealing faces leads to a loss of fluid and/or pressure of the sealed application. This is unacceptable in many applications.

Furthermore, during installation bearing seals are often longitudinally pushed and pulled, or walked, along the shaft, until coming to rest in their final running position. Dawson, U.S. Pat. No. 6,805,358, suffers from rotor hang-up and cockling/seal face separation, as the high levels of frictional resistance, essential to rotationally drive the rotor, compete directly against the ability of the sealing elastomers to be longitudinally responsive under the closing forces of the magnets.

This design weakness is magnified over time given that the rotary drive elastomer will thermally set and “weld” itself onto the shaft. All counter-rotating surfaces wear. As the seal face wears, the welded rotary of U.S. Pat. No. 6,805,358 is unable to move longitudinally to compensate for the seal face wear. This results in the separation of the rotor to stator seal faces and therefore leakage of the sealed media.

Furthermore, a bearing seal design which contains a rotor which, post installation, is out of visual sight to the operator, such is shown in Dawson, U.S. Pat. No. 6,805,358 (FIG. 3) or in Roddis, U.K. Patent Application No. GB 0215750.1, are not installation friendly, since the operator can not see or otherwise detect whether the rotor is cockled or displaced. In many cases, where the seal design permits the longitudinal separation of the contact faces, the mis-installation can only be detected many hours, weeks or months later, when the equipment is commissioned. This can result in lost productivity of the equipment, if said equipment has to be rebuilt in order to fix the leaking bearing seals.

It would be advantageous if a bearing seal is available in which the physical separation of the contact seal faces is eliminated, the seal faces being biased to remain together and in contact during longitudinal shaft displacement and/or during installation.

It would also be of advantage if the rotor of the bearing seal could be viewed post installation.

A further advantage would arise of the stationary seal face has some resilience and/or the unit can be in-field disassembled, thus permitting repair.

### SUMMARY OF THE INVENTION

According to the present invention, there is provided a contacting seal device for providing a seal between equipment housing and an equipment shaft, comprising:
a stator sealable to the equipment housing by a first toroidal sealing member,
a first rotor sealable to the equipment shaft by a second toroidal sealing member,
said stator and said second rotor each having contacting faces,
a second rotor mounted for longitudinal movement relative to said first rotor and sealed to said first rotor by a third toroidal sealing member,
one or more biasing devices urging the contact face of the second rotor into engagement with the contact face of the stator.

Preferably, the third toroidal sealing member is made from a material which has a low co-efficient of friction and this is a low radial squeeze imposed between the two radially disposed counter sliding sealed surfaces, so that the longitudinal movement of the second rotor member is not constrained by substantial forces opposing the spring-biasing forces which urge the two seal faces together.

Preferably, said second rotor is rotationally coupled to, and free to longitudinally float relative to, the first rotor. Preferably, the degree of longitudinal float is longitudinally restricted by a radially extending surface of the first rotor adjacently disposed to a radially extending surface of the second rotor.

Preferably, said second rotor contains a rotor contact seal face member that is longitudinally biased towards a stator contact seal face member.

Preferably, said stator contact seal face member is sealed to the stator by a fourth toroidal sealing member. Preferably said sealing member provides a resilient mount to ensure the longitudinal surfaces of said stator seal face member does not contact a longitudinal surface of said stator housing.

Preferably, the two seal face members are biased together by one or more magnets. Preferably, said magnet is positioned in the stator in an inclined hole relative to the longitudinal shaft axis.

Preferably, said magnet is positioned substantially adjacent to an inclined and substantially magnetically attracted surface of one of the seal faces or the rotor.

Preferably, the first rotor is radially larger and thus covers one or more of the longitudinal surfaces of the stator.

Preferably, said first rotor contains an axial extending cavity adjacent to an inclined stator surface. Said cavity incorporates a toroidal sealing member which forms a seal between the rotor and stator when the equipment is at rest and disengages from the stator and/or rotor surface when the equipment is in operation.

Embodiments of contact seals in accordance with the present invention may be such that the arrangement of substantially inclined surface adjacent to a substantially inclined biasing member can be disposed on any longitudinal surface between counter-rotational members.

Preferably, the contact face of the stator is arranged for longitudinal movement relative to the remainder of the stator and the, or each of said, biasing devices are mounted on said contact face. More preferably, the force urging the contact face of the stator towards the contact face of the rotor is greater than the force urging the contact face of the stator longitudinally towards the remainder of the stator, e.g., by about 50%, in a preferred embodiment.

### DETAILED DESCRIPTION OF THE DRAWING FIGURES

The accompanying drawings are as follows:

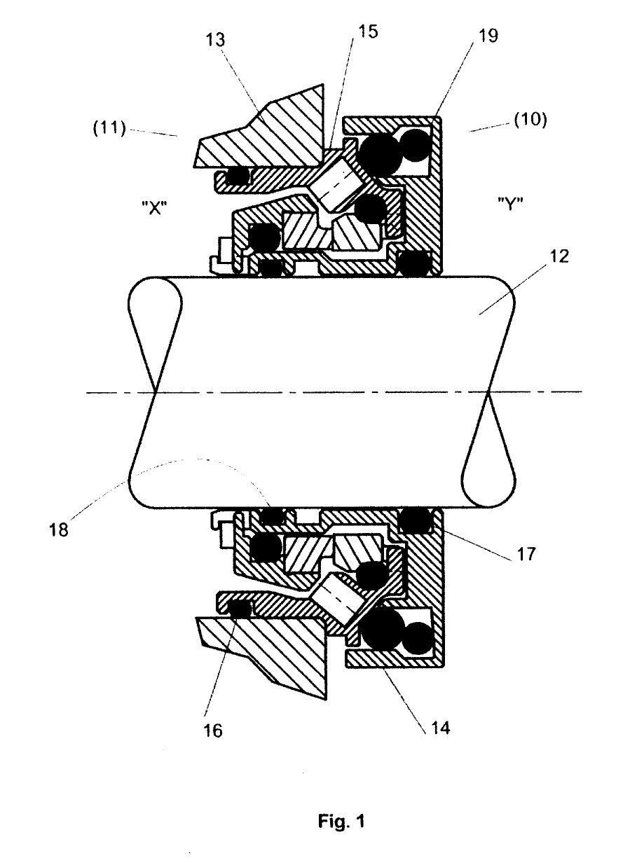

FIG. 1 is a longitudinal sectional view of a first embodiment of a bearing protector of the invention, mounted on a shaft;

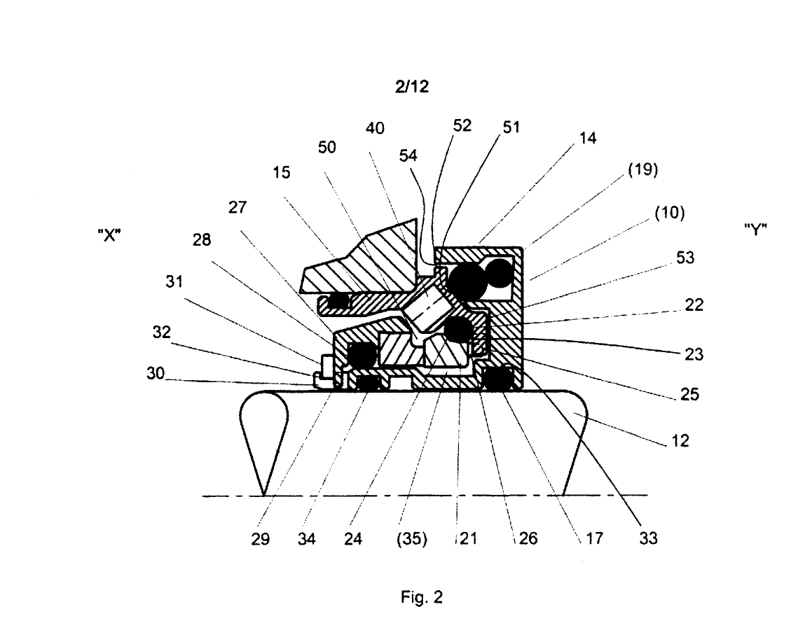

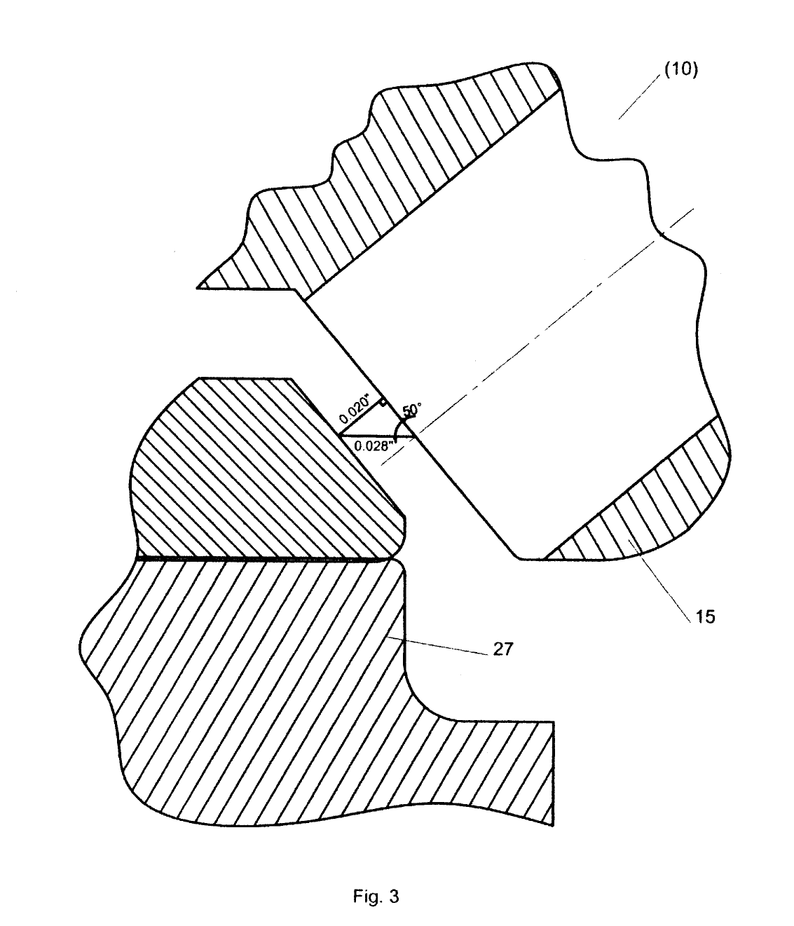

FIG. 2 corresponds to FIG. 1 and shows an enlarged partial cross section through the bearing protector of the invention;

FIG. 3 corresponds to FIG. 2 and shows an enlarged partial cross section through the magnet of the bearing protector of the invention;

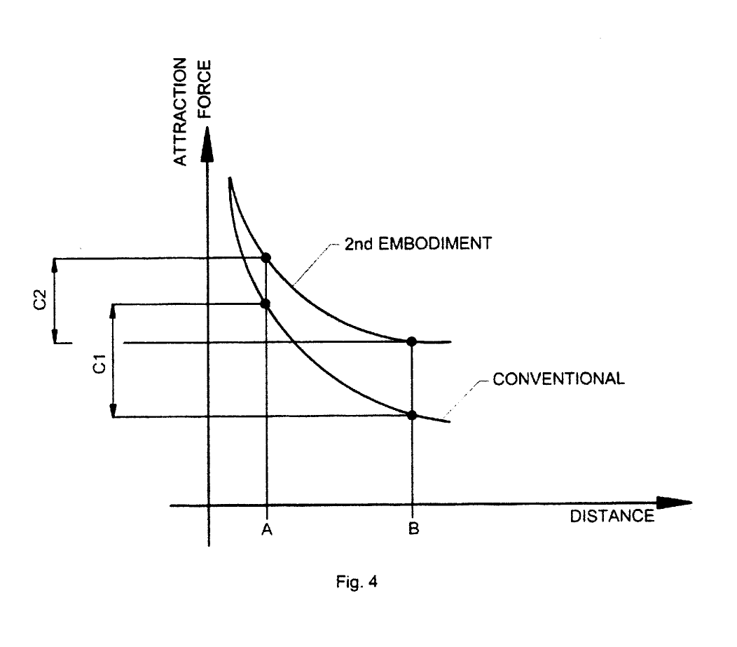

FIG. 4 depicts the variance in magnetic attraction forces for the first embodiment of the invention compared to conventional technology;

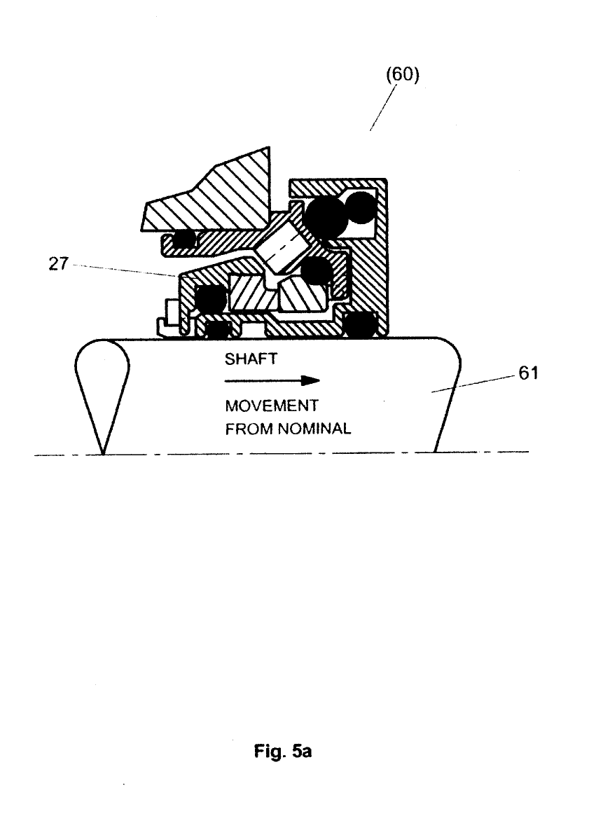

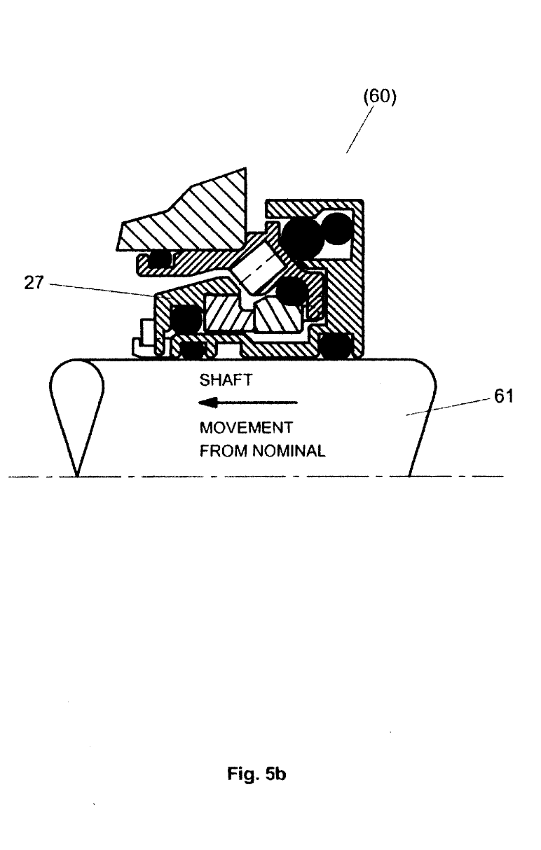

FIG. 5a corresponds to FIG. 2 and is a partial longitudinal section view of the bearing protector mounted on a shaft in a longitudinally extended position;

FIG. 5b corresponds to FIG. 2 and is a partial longitudinal section view of the bearing protector mounted on a shaft in a longitudinally compressed position;

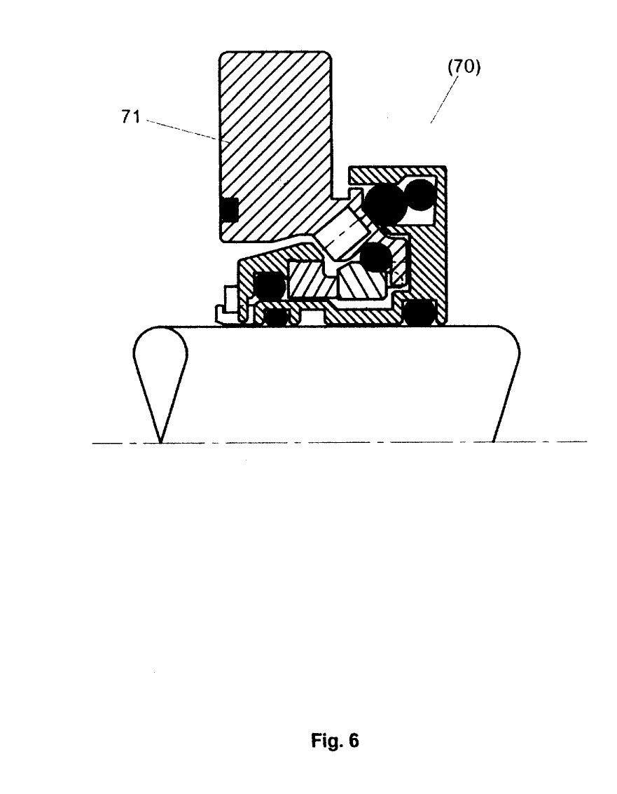

FIG. 6 is a partial longitudinal section view of a second embodiment of a bearing protector of the invention, mounted into an integral gland plate;

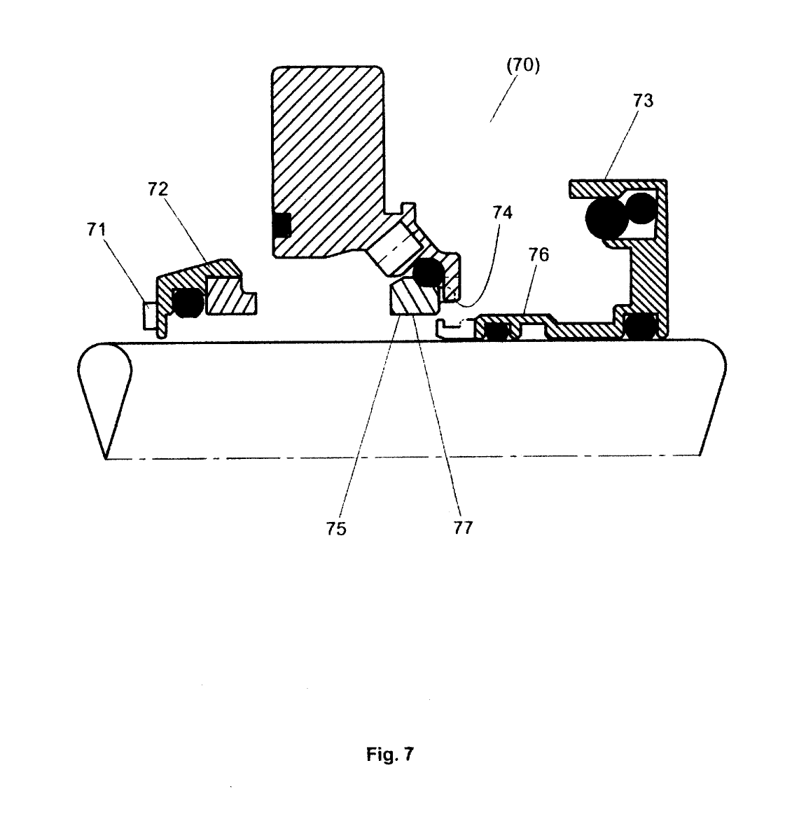

FIG. 7 corresponds to FIG. 6 and is an exploded partial longitudinal section view of the bearing protector illustrating the assembly/disassembly of the device;

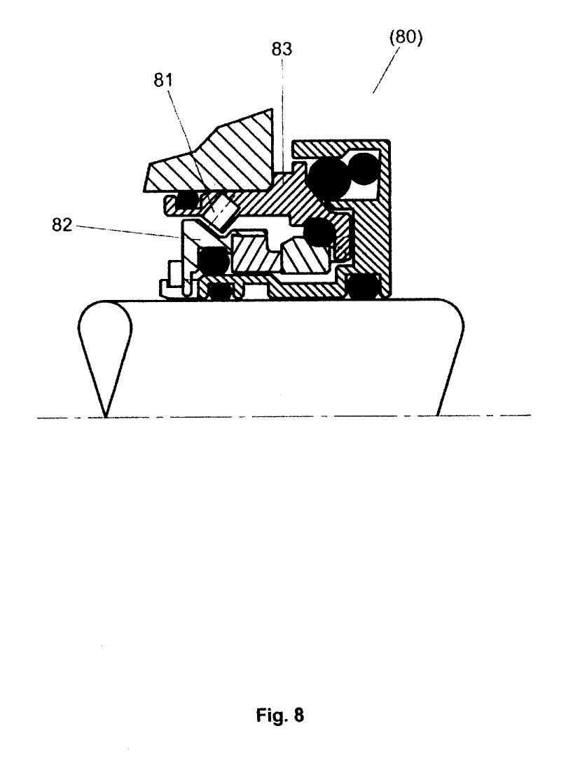

FIG. 8 is a partial longitudinal section view of a third embodiment of a bearing protector of the invention, with magnetic attraction positioned in an alternate longitudinal location;

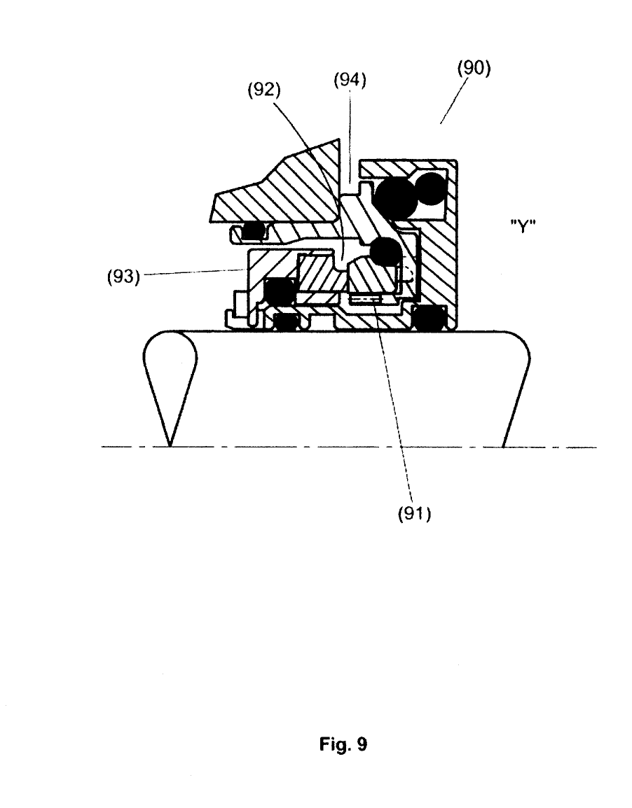

FIG. 9 is a partial longitudinal section view of a fourth embodiment of a bearing protector of the invention, mounted with horizontal magnets;

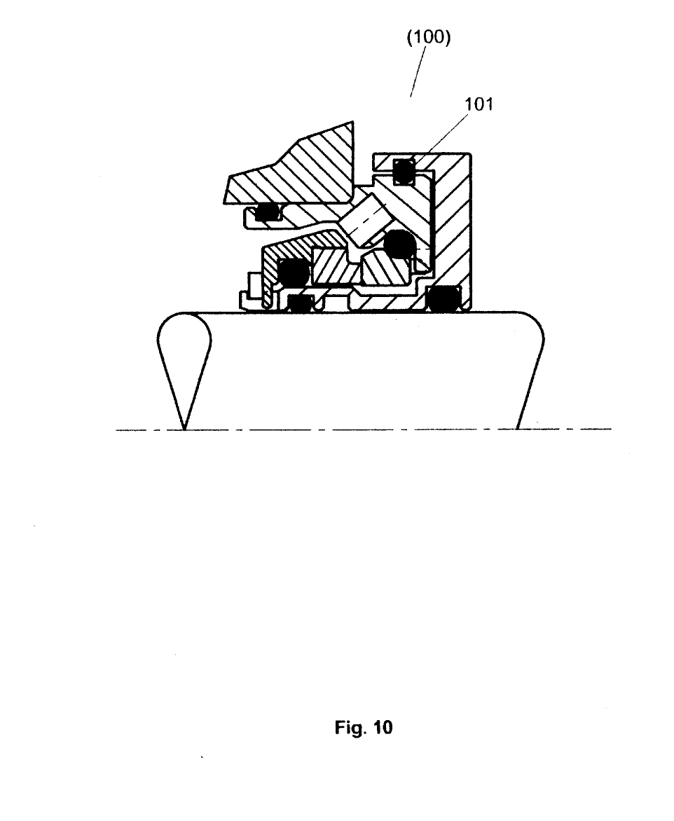

FIG. 10 is a partial longitudinal section view of a fifth embodiment of a bearing protector of the invention, provided with an alternative static shut-off valve assembly; and

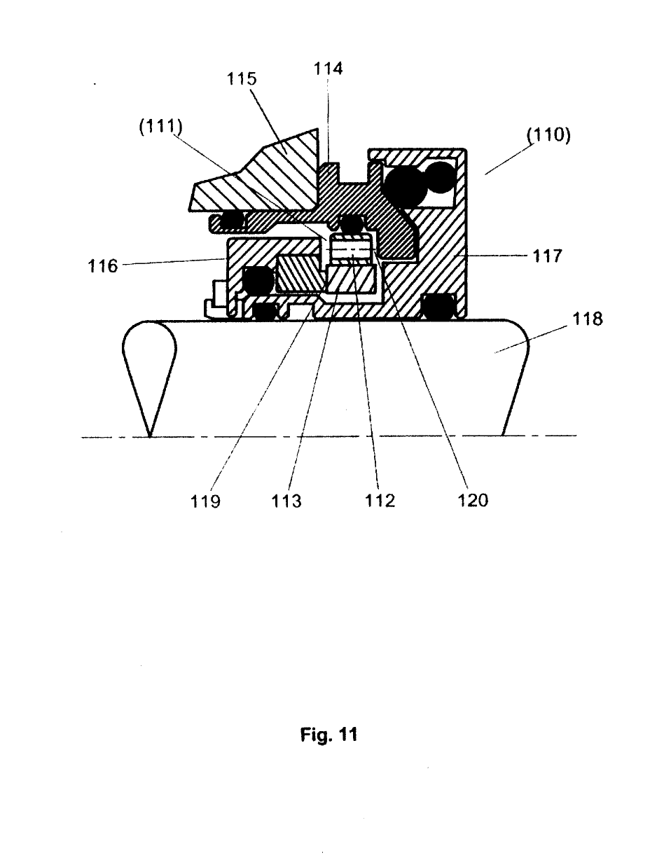

FIG. 11 is a partial longitudinal section view of a sixth embodiment of a bearing protector of the invention, provided with an alternative static biasing means.

### DETAILED DESCRIPTION OF THE DRAWING FIGURES AND PREFERRED EMBODIMENTS

The invention will now be described, by way of examples only, with reference to the accompanying drawings.

In general, rotary seals in accordance with the present invention may be used not only in the case where the shaft is a rotary member and the housing is a stationary member but also the reverse situation, that is to say, in which the shaft is stationary and the housing is rotary.

Furthermore, the invention may be embodied in both rotary and stationary arrangements, cartridge and component seals with metallic components as well as non-metallic components.

Referring to FIG. 1 of the accompanying drawings, there is illustrated an invention, a bearing protector assembly 10 which is fitted to an item of rotating equipment 11. The equipment includes a rotating shaft 12 and a stationary housing 13. The stationary housing 13 could typically contain a bearing, which is not shown.

Area “X” at one axial end of the bearing protector assembly 10 could partially contain fluid and/or solids and/or foreign debris and/or atmosphere. It will be termed “product substance”, a term which is used to describe a single or mixed medium.

Area “Y” at the other axial end of the bearing protector assembly 10 could also partially contain fluid and/or solids and/or foreign debris and/or atmosphere. It will be termed “atmospheric substance” a term which is used to describe the single or mixed medium.

The bearing protector assembly 10 includes a first rotor member 14 which is radially and axially adjacent to a stator member 15.

A stator elastomer 16 provides a radial seal between the housing 13 and stator 15. At least one shaft elastomer 17 provides a radial seal between the shaft 12 and a first rotor 14. A second shaft elastomer 18 is provided, between the first rotor 14 and shaft 12, thereby providing improved support and stability of rotor 14 during dynamic operation.

The static shut off device 19 is similar to that described in our co-pending labyrinth seal bearing protection application GB0415548.7 and will be further described below.

FIG. 2 corresponds to FIG. 1 and shows an enlarged partial cross section through the bearing protector 10 of the invention.

A stator seal face 21 is sealed to the stator 15 by elastomer 22. Preferably, said elastomer 22 abuts to an annular surface 23 of said stator 15 and an annular surface 24 of stator seal face 21 so as to prevent any of the longitudinal surfaces of either stator seal face 21 and stator 15 contacting. This provides a resilient mount to the stator seal face 21, which is advantageous, in applications where there is angular displacement of shaft 12 relative to housing 13.

Preferably, stator seal face 21 has means to rotationally couple it to said stator 15. This is provided by a drive lug 25 of the stator 15 radially extending into a drive slot 26 of stator seal face 21. However, other suitable drive mechanisms may be added.

A second rotor 27 is radially mounted on first rotor 14 and the sliding interface sealed by elastomer 28. Elastomer 28 is preferably manufactured from a substantially hard, wear resistant material, which has a low friction co-efficient. Preferably, the radial compression of elastomer 28 between first rotor 14 and second rotor 27, is minimal and the contacting rotor surfaces contacting the elastomer also have a low friction co-efficient. A low force is therefore required to effect sliding between the rotors.

Second rotor 27 has means to rotationally couple it to said first rotor 14. This is provided by a drive lug 29 of the second rotor 27 radially extending into a drive slot 30 of the first rotor 14, other drive mechanisms may be utilised.

Preferably, second rotor 27 is longitudinally restrained by a radially extending protrusion 31 from first rotor 14. For assembly and disassembly, specifically for in-field repair benefits, protrusion 31 is a detachable circlip which locates in groove 32 of first rotor 14.

As shown, the first rotor 14 is rotationally driven by the shaft 12 by the frictional drive between said shaft 12 and elastomer member 17. Preferably, a high radial compression on elastomeric member 17 between shaft 12 and inner rotor surface 33 is provided and the respective surface finishes, and frictional co-efficients of said components are such to substantially improve said rotational friction drive. A further frictional drive member, with elastomer 34, is also positioned between first rotor 14 and shaft 12.

Bearing seal 10 is intended to seat firmly on the shaft 12, and with any given longitudinal movement of shaft 12, the first rotor 14 will longitudinally displace accordingly while said second rotor 27 longitudinally remains static.

This arrangement ensures that said second rotor 27 slides on said first rotor 14 and thus remains substantially in contact with said stator assembly 35. The longitudinal sliding surfaces of the bearing seal may be engineered into components of the suppliers making and thus are not reliant on the conditions of an item of equipment which could be 50+ years old.

The essence of the first embodiment of the invention is that the rotational drive requirements of the bearing seal device are de-coupled from the longitudinal sliding requirements of the device ensuring a more technically acceptable solution for the bearing seal application. This is clearly also beneficial for installation, given that bearing seals are pushed and pulled along shafts. Such forces do not acting to separate the contacting and substantially sliding counter-rotational seal faces.

At least one magnet 40 is positioned in stator 15 and adjacent to a magnetically attractive surface of the second rotor 27. The magnet 40 is in an inclined orientation relative to the horizontal shaft 12 axis. Providing a physically compact longitudinal arrangement. As a result, the longitudinal space required by the magnet is relatively small and is part achieved by the use of more substantially abundant radial space.

This embodiment further provides a longitudinal spring-biased closing means for the second rotor 27 with respect to the stator 15 in addition to a radial centring bias between the rotor assembly and stator assembly, which is deemed to be of particularly of interest and advantage given the rotor and stator assemblies have no radial setting means and inherent radial clearances during operation.

This embodiment provides yet a further advantage, in that it provides an increased longitudinal gap for a given magnet attraction gap, as shown in FIG. 4.

From FIG. 4, the reader will note that magnets typically have an exponentially decreasing attraction force as the attraction gap, between said magnet and said attracted component, increases.

For this reason, conventional magnetic seal technology, such as FIG. 3 of Dawson, U.S. Pat. No. 6,805,358, dictates a relatively close running clearance between the counter-rotational components.

From FIG. 3, depending on the slope of the incline, the present invention 10 provides a substantially larger longitudinal running clearance, compared to conventional technology, between the counter-rotational components of the stator 15 and second rotor 27.

By way of example only, for an incline of 50 degrees from the horizontal axis, and an attraction clearance of 0.020″ (0.5 mm), the longitudinal running clearance is 0.028″ (0.72 mm) providing a 42% increase in permissible seal face wear and permissible seal face lubrication fluid to cool the seal faces during operation. Conventional mechanical seal technology shows that heat dissipation from the counter-rotational sliding contact between two surfaces is improved as the volume of fluid surrounding said seal faces increases.

Furthermore and possibly more importantly, the first embodiment of the invention provides less magnet attraction variance, between the two attracted members, than what is to be expected from conventional orientation as shown in FIG. 4.

The magnetic attraction force graph, shown in FIG. 4, depicts the changing variance of the first embodiment of the present invention compared to conventional technology. From this graph, it can be seen that for a longitudinal distance of AB, the magnetic attraction force variance, in a conventional, substantially perpendicular to the shaft axis arrangement, equates to C₁. However, given the inclined nature of the first embodiment, over the same longitudinal distance AB, the magnetic variance is provided by C₂.

Given C₂ is substantially smaller than C₁, the first embodiment of the invention provides a substantially more linear seal face closing force ensuring the mechanical seal faces run at closer to their optimised condition over a given period of time.

Returning back to FIG. 2, the static shutoff valve arrangement 19 is preferably positioned towards the atmospheric “Y” side of the bearing seal face assembly 50.

When the equipment is idle, as described in our application GB0415548.7, the static shut-off value positively provides a sealing means between the first rotor 14 and stator 15. Preferably, said stator sealing surface 51 is substantially inclined to the horizontal shaft 12 axis.

When the equipment is operational, the static shut-off valve positively disengages from the stator surface providing a non-contacting interface between the rotor 14 and stator 15.

From the teaching of FIG. 3 of Dawson, U.S. Pat. No. 6,805,358, the reader will note that in vertical-up orientation of said prior-art bearing seal, a moisture cavity is created between the shaft 1 and inner most radial surfaces of stator 16 and face 12. Once moisture enters said cavity, it is unable to drain therefore said moisture and/or debris eventually works its way past the sliding sealing interface and into the bearing cavity.

Referring back to FIG. 2 of the accompanying drawings, the first rotor 14 is radially larger than the stator 15 and comprises an annular surface 52 which longitudinally extends beyond one or more longitudinal annular face 53 of stator 15. Importantly, the static shut-off valve assembly 19 is radially and/or longitudinally positioned adjacent to the counter-rotational interface 54, which is interface exposed to the atmospheric side “Y”.

The experienced above described bearing protector provides a combination of a substantially non-contacting static shut-off device during equipment operation and contacting static shut-off device when the equipment is idle. Moisture is prevented from entering the natural created cavity, between first rotor 14 and stator 15, towards the atmospheric side Y of the mechanical seal faces, whilst providing a mechanical seal face assembly, where the stator seal face and specifically the stator seal face elastomer abutment annular surface 23 is on the atmospheric side Y of the second rotor seal face.

This longitudinal orientation of the second rotor and seal face 27 being spring biased in a longitudinal direction substantially away from the sealed media towards the stator seal face 21, and the stator seal face being positively restrained via the elastomer 22 and stator abutment annular surface 23 is of significant advantage in pressurised and flooded bearing lubrication applications.

FIG. 5a corresponds to FIG. 2 and is a partial longitudinal section view of the bearing protector 60 mounted on a shaft 61 in a longitudinal extended position. The reader will note that the second rotor 27 remains in an identical longitudinal position to that of FIG. 2, despite the shaft 61 having displaced longitudinally to the right.

FIG. 5b corresponds to FIG. 2 and is a partial longitudinal section view of the bearing protector 60 mounted on a shaft 61 in a longitudinal compressed position. The reader will again note that the second rotor 27 remains in an identical longitudinal position to that of FIG. 2 and FIG. 5a, despite the shaft 61 having displaced longitudinally to the left.

FIGS. 5a and 5b thereby illustrates an advantage of the invention, specifically in applications of longitudinal shaft movement and/or bearing seal installation onto the shaft, in that the important mechanical seal faces are not separated in such conditions. This is due to the decoupling of the longitudinal frictional sealing resistance of the sealing elastomers from the rotational frictional sealing resistance.

FIG. 6 is a partial longitudinal section view of an alternative bearing protector of the invention 70, mounted into an integral gland plate 71.

FIG. 7 corresponds to FIG. 6 and is an exploded partial longitudinal section view of the bearing protector 70 of the invention illustrating the assembly/disassembly of the device.

Clearly, from FIG. 7, the restraining circlip 71 is removed permitting the second rotor 72 to be longitudinally displaced to the left and the first rotor 73 to be longitudinally displaced to the right. From this exploded view it can be seen how the bearing protector of the invention is designed to be easily in-field repaired.

The rotor assembly comprises a first rotor 73 and a second rotor 72 arranged in such a way that both longitudinal annular ends of the assembly are radially larger than the inner most region of the stator 74 and/or stator seal face 75.

In the two part rotor assembly, the outer surface 76 of the first rotor 73 must be radially smaller than the innermost surface of the stator 77 in order for the members to longitudinally pass each other. Preferably, the longitudinal retainment mechanism 71 must be positioned adjacent to a longitudinally annular surface of the second part of the rotor assembly, namely, the second rotor and serves to longitudinally couple both parts of the rotor together.

Clearly, other than the two part rotor example shown and described, there are multiple component configurations that one can create to produce this arrangement, including three or more parts, and including a variety of longitudinal retainment methods such as screws.

FIG. 8 is a partial longitudinal section view of an alternative bearing protector 80 of the invention, with magnetic attraction 81 positioned in an alternative longitudinal location between the rotor 82 and stator 83.

FIG. 9 is a partial longitudinal section view of an alternative bearing protector 90 of the invention, mounted with horizontal magnets 91, by way of example only. Said magnets 91 are positioned at the atmospheric side “Y” of the mechanical seal faces 92 and the static shut-off mechanism is positioned to the atmospheric side of the magnets 911 thereby providing a shielded magnetic attraction on a single face seal, between the rotor assembly 93 and stator assembly 94 with the magnets positioned out of the bearing lubrication media being sealed.

FIG. 10 is a partial longitudinal section view of an alternative bearing protector 100 of the invention, provided with an alternative static shut-off valve assembly 101.

FIG. 11 is a partial longitudinal section view of an alternative bearing protector 110 of the invention, provided with an alternate static biasing means 111.

From FIG. 11, one or more spring-like biasing means 112 are positioned in the stationary seal face 113 which is rotationally connected to the stator 114 and which is preferably rotationally connected to the equipment stator 115.

As previously described, the rotor seal face 116 is rotationally connected to a rotor carrier 117, which is preferably rotationally connected to the equipment rotor or shaft 118.

In operation, one or more spring-like members 112, such as a magnet, longitudinally biases the rotor seal face 116 to the stator seal face 113 to form a counter rotational sealing surface 119.

Preferably, said spring-like member 112, or a further spring-like member (not shown), acts to attract stator seal face 113 to the stator 114 at longitudinal position 120.

In practice, the embodiment of FIG. 11 provides a means for said stator seal face 113 to longitudinally float with respect to the stator 114, preferably in addition to said rotor seal face 116 longitudinally floating with respect to the rotor carrier 117 and/or shaft 118.

Preferably the longitudinal attraction between the stator seal face 113 and rotor seal face 116 is greater than the longitudinal attraction between the stator seal face 113 and the stator 114, thereby always ensuring the counter rotational sealing surface 119 remains closed and in contact at all times in the event of longitudinal displacement occurring in the arrangement.

In practice the spring-like biasing between the stator seal face 113 and stator 114 should ideally be around 50% of the spring-like biasing between the stator seal face 113 and the rotor seal face 116, thereby ensuring counter rotational contact at 119 at all times.

Accordingly, the above-described arrangement will allow longitudinal movement of rotor seal face 116 relative to stator 114 but, due to the attraction between rotor seal face 116 and stator seal face 113, without breaking contact between the seal faces. In this way, the possibility of misalignment occurring during, for instance, installation of the seal is avoided. This is in contrast to the arrangement in Dawson, U.S. Pat. No. 6,805,358 where separation of the seal faces occurs on relative longitudinal displacement of the rotor.

What is claimed is:

1. A contacting seal device for providing a seal between equipment housing and an equipment shaft, comprising:
a stator sealable to an equipment housing by a first toroidal sealing member, said stator having a contact face;
a first rotor sealable to an equipment shaft by a second toroidal sealing member;
a second rotor mounted for longitudinal movement relative to said first rotor and sealed to said first rotor by a third toroidal sealing member, said second rotor having a contact face; and,
at least one biasing device urging said contact face of said second rotor into engagement with said contact face of the stator.

2. The contacting seal device according to claim 1, wherein the third toroidal sealing member is made of a material having a low coefficient of friction and there being a low radial squeeze imposed between said first rotor and said second rotor.

3. The contacting seal device according to claim 1, wherein said second rotor is rotationally coupled to, and free to longitudinally float with respect to, said first rotor.

4. The contacting seal device according to claim 3, wherein the degree of longitudinal float is restricted by a radially extending surface of said first rotor positioned adjacent a radially extending surface of said second rotor.

5. The contacting seal device according to claim 1, wherein said second rotor includes a rotor contact seal face member longitudinally biased towards a contact seal face member of said stator.

6. The contacting seal device according to claim 5, wherein said contact seal face member of said stator is sealed to said stator by a fourth toroidal sealing member.

7. The contacting seal device according to claim 6, wherein the fourth toroidal sealing member provides a resilient mount for ensuring that longitudinal surfaces of said contact seal face member of said stator do not contact a longitudinal surface of a housing for said stator.

8. The contacting seal device according to claim 5, wherein said rotor contact seal face member and said contact seal face member of said stator are biased together via biasing means.

9. The contacting device according to claim 8, wherein said biasing means are magnetic biasing means.

10. The contacting seal device according to claim 9, wherein said magnetic biasing means includes at least one magnet mounted in said stator.

11. The contacting seal device according to claim 10, wherein said at least one magnet mounted with its longitudinal axis inclined to a longitudinal axis of said contacting seal device.

12. The contacting seal device according to claim 11, wherein said at least one magnet is positioned adjacent to a magnetically attractive surface of said second rotor.

13. The contacting seal device according to claim 1, wherein said first rotor has a longitudinally extending cavity adjacent an inclined stator surface.

14. The contacting seal device according to claim 13, wherein the longitudinally extending cavity is capable of accommodating a torroidal sealing member forming a seal between the rotor and stator when the equipment is at rest and which disengages from the stator or rotor surface, or both, when the equipment is in operation.

15. The contacting seal device according to claim 1, wherein said contact face of said stator is arranged for longitudinal movement relative to a remainder portion of said stator and with biasing means being mounted on said contact face for biasing said contact face of said stator toward of said second rotor.

16. The contacting seal device according to claim 15, wherein a first force biasing said contact face of said stator towards said contact face of said second rotor is greater than a second force urging said contact face of said stator longitudinally towards said remainder portion of said stator.

17. The contacting device according to claim 16, wherein the said first force is about 50% greater than said second force.
